(19) United States
(12) Patent Application Publication
(10) Pub. No.: US 2004/0227364 A1
(43) Pub. Date: Nov. 18, 2004

(54) Sieve litter scoop

(76) Inventors: Tapas K. Pain, Woodbridge (CA); Paul W. Dorsett, Mississauga (CA)

Correspondence Address: Tapas K. Pain, P.O. Box 96598, 2414 Major Mackenzie Drive, Vaughan Ontario, L6A1R8, CA

(21) Appl. No.: 10/438,967

(22) Filed: May 15, 2003

(51) Int. Cl. A01K 29/00; B07B 1/02

(52) U.S. Cl. 294/1.3; 294/55

(57) ABSTRACT

The present invention provides an animal refuse scoop comprising a scoop, and a handle attached to the scoop. The scoop defines a top and bottom surface, and a plurality of openings therein. The openings are defined to allow the passage of litter granules therethrough. A cover, having a solid body and a handle attached to the solid body, is pivotably attached to the scoop handle, with the cover solid body being adjacent to the scoop bottom surface. The cover solid body is adapted to matingly cover the scoop openings. A biasing means is attached to the handle, and engages the cover, allowing movement of the cover between a closed position wherein the cover handle is disposed away from the scoop handle and the cover solid body is adjacent to the scoop bottom surface and matingly covering the scoop openings, and an open position wherein the cover is disposed away from the scoop bottom surface and the cover handle is adjacent to the scoop handle. The biasing means biases the cover into the closed position.

### FIELD OF INVENTION

The present invention relates to animal refuse scoops, and more particularly to scoops for use with clumping animal litter.

### BACKGROUND OF THE INVENTION

Domesticated animals such as cats are often trained to use litter boxes for defecation and urination. These litter boxes are typically filled with some type of disposable litter, which is usually comprised of some sort of fine absorbent granules. A particularly useful type of disposable litter is a clumping litter, such as the type disclosed in Canadian patent nos. 2,323,103; 2,233,406 and 2,225,328. Clumping litter allows a user to clean the litter box by removing solidified clumps of litter, that have been coagulated together by an animal's urine, or attached to wet/fresh faeces, to form a clumped mass.

To remove such clumped masses of litter, the user should, for hygienic reasons, preferably employ a scoop. Numerous animal refuse scoops are disclosed in the prior art. Recently, animal refuse scoops have been adapted to work particularly well with clumping litter in that these scoops provide openings to allow the non-clumped granules to fall through the scoop, and back in to the litter box. For example, the scoops disclosed in U.S. Pat. No. 6,312,029 and U.S. Des. patent no. D332,675 are particularly well suited for use with clumping litter. These scoops operate as sifting scoops, which allow the user to preserve and conserve unused litter by keeping most of the unused litter in the litter box.

A problem with these sifting scoops results from the fact that very often, the user will have to travel some distance from the litter box to a place of disposal, such as a garbage can, to dispose of the clumped masses. During transport, litter granules that are held loosely to the clumped mass will typically fall away from the clumped mass, travel through the openings in the sifting scoop, and wind up on the user's floor or carpet. Cleaning these loose granules is a nuisance, and the granules having been in contact with urine and faeces, are unhygienic.

### SUMMARY OF THE INVENTION

The present invention discloses an animal refuse scoop comprising a scoop, and a handle attached to the scoop. The scoop defines a top and bottom surface, and a plurality of openings therein. The openings are defined to allow the passage of litter granules therethrough. A cover, having a solid body and a handle attached to the solid body, is pivotably attached to the scoop handle, with the cover solid body being adjacent to the scoop bottom surface. The cover solid body is adapted to matingly cover the scoop openings. A biasing means is attached to the handle, and engages the cover, allowing movement of the cover between a closed position wherein the cover handle is disposed away from the scoop handle and the cover solid body is adjacent to the scoop bottom surface and matingly covering the scoop openings, and an open position wherein the cover is disposed away from the scoop bottom surface and the cover handle is adjacent to the scoop handle. The biasing means biases the cover into the closed position.

### DESCRIPTION OF THE DRAWINGS

FIG. 1 is a perspective view of a sifting cat litter scoop known in the prior art.

FIG. 2 is a perspective view of the present invention with the scoop cover in the closed position.

FIG. 3 is a cross-sectional view taken along the lines 3-3 in FIG. 2.

FIG. 4 is a cross-sectional view similar to FIG. 3 with the scoop cover in the open position.

FIG. 5 is a cross-sectional view similar to FIG. 3 showing an alternate biasing means.

FIG. 6 is a cross-sectional view similar to FIG. 4 showing an alternate biasing means.

### DETAILED DESCRIPTION OF THE DRAWINGS

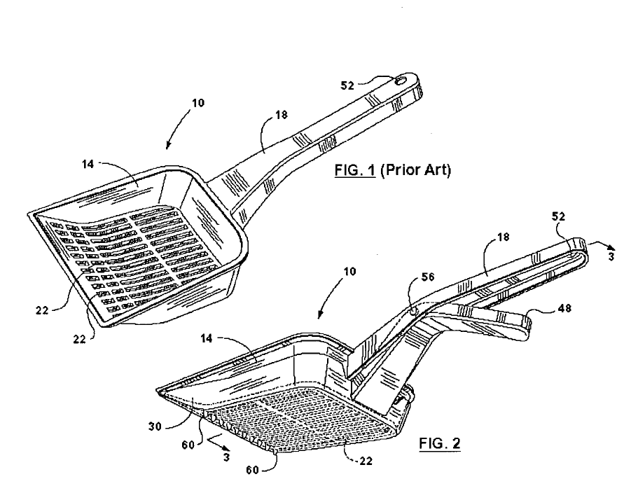

In accordance with the present invention, FIG. 2 shows a cat litter scoop (10) having a scoop portion (14) and a handle (18) attached thereto.

The scoop (14) defines a top (26) and bottom (30) surface, and a plurality of openings (22) therein (the openings (22) are best seen in FIG. 1). The openings (22) are defined to allow the passage of litter granules (68) therethrough. The openings (22) can be rectangular, circular, or any other shape or orientation so long as they permit the passage of litter granules (68) therethrough. Similarly, the scoop (14) can be any shape so long as it is functional for dragging through a cat litter box (not shown).

The handle (18) can, at an end opposite to the scoop (14), define an opening (52) (best seen in FIG. 1) for allowing the passage of a nail or hook (not shown) therethrough, for hanging the scoop (10) on a wall (not shown).

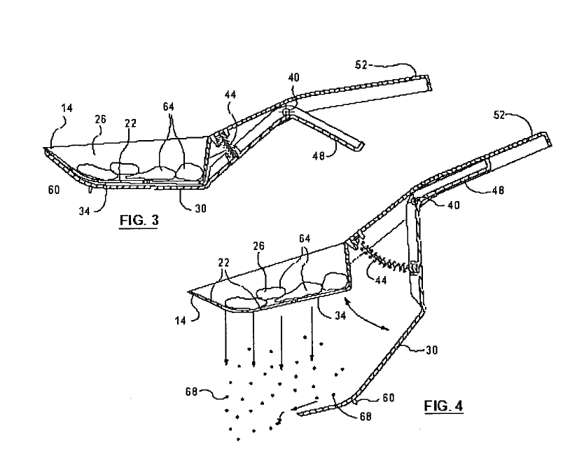

A cover having a solid body (34) and a handle (48) is attached to the scoop (10). The cover body (34) is preferably pivotably attached to the scoop handle (18). One possible method for pivotably attaching the cover (34) to the handle (18) is to provide grooves or openings (40) (best seen in FIGS. 3 and 4) in the handle (18), to receive pins (56) (best seen in FIG. 2) attached to the handle (48). This arrangement of pins (56) and grooves or openings (40) can be reversed with respect to the cover handle (48) and the handle (18). The pivotable arrangement can also be modified to allow the cover (34) to be releasable or removable from the handle (18) (to facilitate cleaning of the scoop (10)).

The cover body (34) can optionally define projecting fingers (60) (best seen in FIG. 2) for raking litter in a litter box (not shown), to give the litter a smooth surface.

When in its normal resting position (FIG. 2) (i.e. the “closed position”), the cover (34) is adjacent to the scoop (14) bottom surface (30). The cover (34) is adapted to matingly cover the scoop (14) openings (22). The cover (34) preferably corresponds in shape to the scoop (14) so that the cover (34) can matingly engage the scoop (14). For design purposes, the cover (34) can be of a different shape and configuration from the scoop (14), so long as the cover (34) matingly covers the scoop (14) openings (22).

The cover handle (48), in the closed position, is disposed away from the scoop handle (18). The cover handle (48) can be varied in length, to permit either simple one finger squeezing operation with a small handle (48), or multiple finger squeezing operation with a longer handle (48).

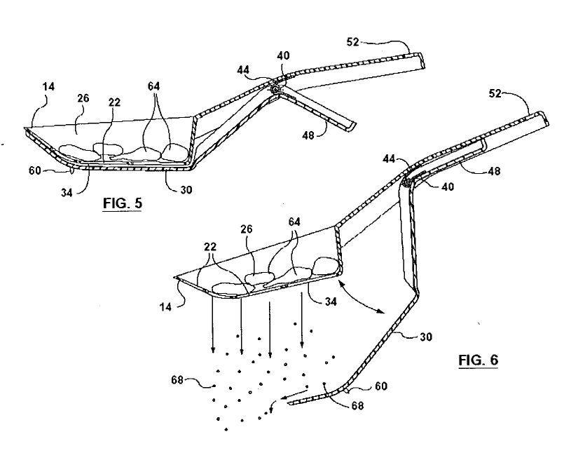

To maintain the scoop (10) in its closed position (see FIG. 1), a biasing means such as a tension spring (44) (best seen in FIG. 3) can be applied to the scoop (14) bottom surface (30) or the handle (18). The spring (44) engages the cover (34) and handle (48), and biases them toward the normal closed position. The biasing means is not limited to the tension spring (44) type. A suitable alternative biasing means comprises a flexible tongue (not shown) depending from the handle (18), and engaging the cover (34) so as to bias the cover (34) against the scoop (14). Yet another type of biasing means is shown in FIGS. 5 and 6 wherein a resilient wound coil (44) is provided to bias the handle (48) and cover (34) into the closed position. Many other biasing means mechanisms are possible.

When a user (not shown) squeezes the handle (48), the cover (34) is biased into the open position wherein the cover (34) is disposed away from the scoop bottom surface (30) openings (22), and the handle (48) is adjacent the scoop handle (18) (see FIG. 4).

It is also possible to design the cat litter scoop (10) so that the cover (34) is normally biased in the open position. However, such a design would make it cumbersome to store the cat litter scoop (10) when not in use.

In operation, the scoop (14) and cover (34) are inserted into a cat litter box (not shown) filled with clumping cat litter (not shown). The scoop (14) is dragged across and through the cat litter. While dragging the scoop (14) through the litter, the user can bias the cover (34) into the open position. If the cover (34) is maintained in the closed position during dragging, the amount of cat litter that can pass through the scoop (14) is more limited than if the cover (34) is in the open position.

When the scoop (14) is lifted out of the litter box (not shown), the user squeezes the handles (18, 48) together, resulting in the cover (34) moving to the open position. Clumped masses (64) are retained within the scoop (14) while the non-clumped litter granules (68) freely pass through the scoop openings (22) (FIG. 4), and back into the litter box.

Once the free litter granules (68) have passed through the scoop openings (22), the user can release the handle (48) allowing the cover to return to the closed position. The clumped masses (64) can then be transported to a site of garbage disposal without allowing the passage of free litter granules through the scoop openings (22).

What is claimed is:

1. An animal refuse scoop comprising:
(i) a scoop;
(ii) a handle attached to the scoop;
(iii) the scoop defining a top surface and a bottom surface, and a plurality of openings therein, the openings being defined to allow granules to pass therethrough;
(iv) a cover having a solid body and a handle attached to said solid body, the cover being pivotably attached to the scoop handle, the cover solid body being adjacent to the scoop bottom surface and adapted to matingly cover the scoop openings;
(v) a biasing means attached to the handle, the biasing means engaging the cover and being adapted to allow movement of the cover between a closed position wherein the cover handle is disposed away from the scoop handle and the cover solid body is adjacent to the scoop bottom surface and matingly covering the scoop openings, and an open position wherein the cover is disposed away from the scoop bottom surface and scoop openings, and the cover handle is adjacent to the scoop handle; and
(vi) the biasing means biases the cover into the closed position.

2. The animal refuse scoop as defined in claim 1 wherein the biasing means is a tension spring.

3. The animal refuse scoop as defined in claim 1 wherein the biasing means is a wound coil.

4. The litter scoop as defined in claim 1 further comprising a plurality of fingers attached to the cover solid body.

5. The litter scoop as defined in claim 1 wherein the cover is pivotably releasably attached to the scoop handle.
